(19) United States
(12) Patent Application Publication
(10) Pub. No.: US 2025/0252581 A1
(43) Pub. Date: Aug. 7, 2025

(54) TRAINING METHOD FOR IMAGE GENERATION MODEL, IMAGE GENERATION METHOD, DEVICE AND STORAGE MEDIUM

(71) Applicant: BEIJING BAIDU NETCOM SCIENCE TECHNOLOGY CO., LTD., Beijing (CN)

(72) Inventors: Zongcai Du, Beijing (CN); Yafei Zhao, Beijing (CN); Xirui Fan, Beijing (CN); Yi Chen, Beijing (CN); Zhiqiang Wang, Beijing (CN); Qin Qin, Beijing (CN)

(73) Assignee: BEIJING BAIDU NETCOM SCIENCE TECHNOLOGY CO., LTD., Beijing (CN)

(21) Appl. No.: 18/986,392

(22) Filed: Dec. 18, 2024

(30) Foreign Application Priority Data
Feb. 7, 2024 (CN) 202410175508.9

(51) Int. Cl. G06T 7/246; G06V 30/18; G10L 25/57

(52) U.S. Cl. CPC G06T 7/246; G06V 30/18143; G10L 25/57; G06T 2207/20081

(57) ABSTRACT

Provided are a training method for an image generation model, an image generation method, apparatus, and a device. The training method includes extracting reference keypoints of a character from a sample reference image; based on a model to be trained, performing motion estimation using sample audio data and the reference keypoints to obtain predicted keypoints that match the sample audio data; performing parameter estimation using the reference keypoints and the predicted keypoints to obtain motion parameters of the predicted keypoints, and performing prior motion estimation using the motion parameters of the predicted keypoints to obtain optical flow of non-key pixel points; performing image prediction using the sample reference image and dense optical flow to obtain predicted image data that matches the sample audio data; performing model training using the predicted image data and annotated image data to obtain the image generation model.

### CROSS-REFERENCE TO RELATED APPLICATION

This application claims priority to Chinese Patent Application No. CN 202410175508.9, filed on Feb. 7, 2024, the disclosure of which is incorporated herein by reference in its entirety.

### TECHNICAL FIELD

The present disclosure relates to the field of computers, in particular, the field of artificial intelligence technologies, including augmented reality (AR), virtual reality (VR), computer vision, deep learning, and other technical fields. The present disclosure may be applied to scenarios such as the metaverse and virtual digital humans. For example, the present disclosure involves a training method for an image generation model, an image generation method, apparatus, and a device.

### BACKGROUND

A virtual human, also known as a digital human, refers to a virtual character with a digital appearance. The virtual human exists through display devices and possesses human-like appearance, gestures (able to speak and raise hands), and thoughts. The generation of virtual humans is a key technology in scenarios such as the metaverse, intelligent customer service, and e-commerce. The core of the generation of virtual humans is to generate continuous and realistic digital human images, with extensive application scenarios and commercial demand.

How to generate digital human images is of significant importance.

### SUMMARY

The present disclosure provides a training method for an image generation model, an image generation method, apparatus, and a device.

According to an aspect of the present disclosure, a training method for an image generation model is provided. The method includes the steps below.

Sample audio data, a sample reference image, and annotated image data are acquired, and reference keypoints of a character are abstracted from the sample reference image.

Based on a model to be trained, motion estimation is performed using the sample audio data and the reference keypoints to obtain predicted keypoints that match the sample audio data.

Based on the model to be trained, parameter estimation is performed using the reference keypoints and the predicted keypoints to obtain motion parameters of the predicted keypoints, and prior motion estimation is performed using the motion parameters of the predicted keypoints to obtain optical flow of non-key pixel points.

Based on the model to be trained, image prediction is performed using the sample reference image and dense optical flow to obtain predicted image data that matches the sample audio data, where the dense optical flow includes optical flow of the predicted keypoints and the optical flow of the non-key pixel points.

Model training is performed using the predicted image data and the annotated image data to obtain the image generation model.

According to an aspect of the present disclosure, an image generation method is provided. The method includes steps described below.

Target audio data and a target reference image are acquired, and reference keypoints of a character are extracted from the target reference image.

Based on an image generation model, motion estimation is performed using the target audio data and the reference keypoints to obtain predicted keypoints that match the target audio data.

Based on the image generation model, parameter estimation is performed using the reference keypoints and the predicted keypoints to obtain motion parameters of the predicted keypoints, and prior motion estimation is performed using the motion parameters of the predicted keypoints to obtain optical flow of non-key pixel points.

Based on the image generation model, image prediction is performed using the target reference image and dense optical flow to obtain predicted image data that matches the target audio data, where the dense optical flow includes optical flow of the predicted keypoints and the optical flow of the non-key pixel points.

According to an aspect of the present disclosure, a training apparatus for an image generation model is provided. The apparatus includes a reference keypoint module, a predicted keypoint module, an optical flow estimation module, an image prediction module, and a model training module.

The reference keypoint module is configured to acquire sample audio data, a sample reference image, and annotated image data and extract reference keypoints of a character from the sample reference image.

The predicted keypoint module is configured to: based on a model to be trained, perform motion estimation using the sample audio data and the reference keypoints to obtain predicted keypoints that match the sample audio data.

The optical flow estimation module is configured to: based on the model to be trained, perform parameter estimation using the reference keypoints and the predicted keypoints to obtain motion parameters of the predicted keypoints and perform prior motion estimation using the motion parameters of the predicted keypoints to obtain optical flow of non-key pixel points.

The image prediction module is configured to: based on the model to be trained, perform image prediction using the sample reference image and dense optical flow to obtain predicted image data that matches the sample audio data, where the dense optical flow includes optical flow of the predicted keypoints and the optical flow of the non-key pixel points.

The model training module is configured to perform model training using the predicted image data and the annotated image data to obtain the image generation model.

According to an aspect of the present disclosure, an image generation apparatus is provided. The apparatus includes a reference keypoint module, a predicted keypoint module, an optical flow estimation module, and an image prediction module.

The reference keypoint module is configured to acquire target audio data and a target reference image and extract reference keypoints of a character from the target reference image.

The predicted keypoint module is configured to: based on an image generation model, perform motion estimation using the target audio data and the reference keypoints to obtain predicted keypoints that match the target audio data.

The optical flow estimation module is configured to: based on the image generation model, perform parameter estimation using the reference keypoints and the predicted keypoints to obtain motion parameters of the predicted keypoints and perform prior motion estimation using the motion parameters of the predicted keypoints to obtain optical flow of non-key pixel points.

The image prediction module is configured to: based on the image generation model, perform image prediction using the target reference image and dense optical flow to obtain predicted image data that matches the target audio data, where the dense optical flow includes optical flow of the predicted keypoints and the optical flow of the non-key pixel points. According to another aspect of the present disclosure, an electronic device is provided.

The electronic device includes at least one processor and a memory communicatively connected to the at least one processor.

The memory stores instructions executable by the at least one processor. The instructions are executed by the at least one processor to cause the at least one processor to perform the method according to any embodiment of the present disclosure.

According to another aspect of the present disclosure, a non-transitory computer-readable storage medium is provided. The storage medium stores computer instructions configured to cause a computer to perform the method according to any embodiment of the present disclosure.

According to another aspect of the present disclosure, a computer program product is provided. The computer program product includes a computer program that, when executed by a processor, performs the method according to any embodiment of the present disclosure.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure. In the drawings:

FIG. 1A is a flowchart of a training method for an image generation model according to an embodiment of the present disclosure.

FIG. 1B is a diagram of the training principle for an image generation model according to an embodiment of the present disclosure.

FIG. 2 is another flowchart of the training method for an image generation model according to an embodiment of the present disclosure.

FIG. 3A is still another flowchart of the training method for an image generation model according to an embodiment of the present disclosure.

FIG. 3B is a diagram illustrating the processing of a sample reference image according to an embodiment of the present disclosure.

FIG. 3C is a diagram of the training principle for an image generation model according to an embodiment of the present disclosure.

FIG. 4 is a flowchart of an image generation method according to an embodiment of the present disclosure.

FIG. 5 is another flowchart of the image generation model according to an embodiment of the present disclosure.

FIG. 6A is still another flowchart of the image generation model according to an embodiment of the present disclosure.

FIG. 6B is a flowchart illustrating the principle of image generation according to an embodiment of the present disclosure.

FIG. 7 is a diagram illustrating the structure of a training apparatus for an image generation model according to an embodiment of the present disclosure.

FIG. 8 is a diagram illustrating the structure of an image generation apparatus according to an embodiment of the present disclosure.

FIG. 9 is a block diagram of an electronic device for implementing a training method for an image generation model or an image generation method according to an embodiment of the present disclosure.

### DETAILED DESCRIPTION

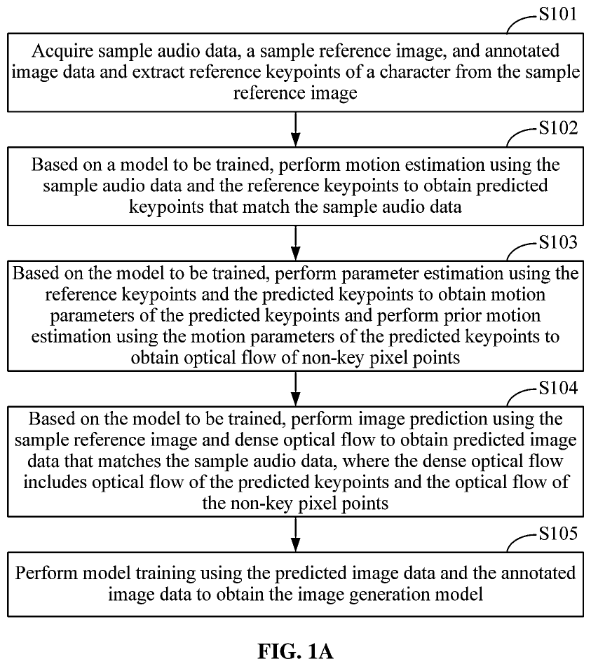

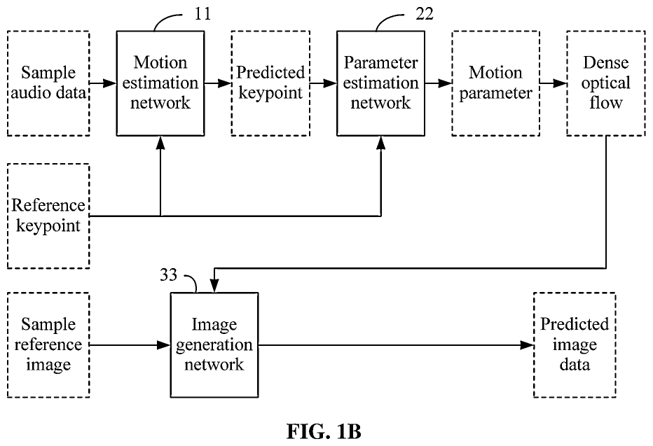

FIG. 1A is a flowchart of a training method for an image generation model according to an embodiment of the present disclosure. The method is applicable to the case where an image generation model is trained based on motion prior. The method may be performed by a training apparatus for an image generation model. The apparatus may be implemented by software and/or hardware and may be integrated into an electronic device. As shown in FIG. 1A, the training method for an image generation model provided by the embodiment may include S101 to S105.

In S101, sample audio data, a sample reference image, and annotated image data are acquired, and reference keypoints of a character are abstracted from the sample reference image.

In S102, based on a model to be trained, motion estimation is performed using the sample audio data and the reference keypoints to obtain predicted keypoints that match the sample audio data.

In S103, based on the model to be trained, parameter estimation is performed using the reference keypoints and the predicted keypoints to obtain motion parameters of the predicted keypoints, and prior motion estimation is performed using the motion parameters of the predicted keypoints to obtain optical flow of non-key pixel points.

In S104, based on the model to be trained, image prediction is performed using the sample reference image and dense optical flow to obtain predicted image data that matches the sample audio data, where the dense optical flow includes optical flow of the predicted keypoints and the optical flow of the non-key pixel points.

In S105, model training is performed using the predicted image data and the annotated image data to obtain the image generation model.

The embodiment of the present disclosure proposes a training method for an image generation model based on motion prior. By introducing prior information about motion during model training, the learning difficulty of the model is significantly reduced, and the training efficiency of the model is improved. The image generation model is used to generate digital human images that match audio so that the facial expressions and limb movements of the digital human images, particularly lip movements, match the audio. The input of the image generation model is continuous audio data and reference images, while the output is a video with coherent lip and limb movements. The movement of the character in the video matches the audio.

Sample audio data, a sample reference image, and annotated image data are acquired. A single piece of sample audio data has a preset fixed duration, such as 800 ms, and a single piece of sample audio data may correspond to a frame of sample reference images as well as annotated image data whose duration is also a fixed value. The movements of the character depicted in the annotated image data match the sample audio data. Overlapping occurs between different sample audio data and between different annotated image data so that the images generated by the model are continuous, thereby enhancing image generation quality.

In the embodiment of the present disclosure, the sample reference image may be preprocessed to obtain reference keypoints of the character in the sample reference image. In an embodiment, keypoint detection may be performed on the sample reference image to obtain the reference keypoints. The reference keypoints are used to provide the initial position of the character during model training so that the model knows the approximate spatial positions of the character's face, limbs, and other parts of the body, thereby improving learning quality of the model.

With reference to 1B, the model to be trained may include a motion estimation network 11, a parameter estimation network 22, and an image generation network 33. The motion estimation network 11 may be used to predict predicted keypoints at time t based on the sample audio data at time t and reference keypoints. The reference keypoints and predicted keypoints at time t are then input into the parameter estimation network 22 to obtain the motion parameters of the predicted keypoints at time t. The motion parameters of the predicted keypoints are used for prior motion estimation to obtain the optical flow of non-key pixel points, that is, to obtain the optical flow of ordinary pixel points around the predicted keypoints. The motion parameters of the predicted keypoints include both the optical flow of the predicted keypoints and the influence parameters of the predicted keypoints on surrounding pixel points. The optical flow of each predicted keypoint and the optical flow of each non-key pixel point may form the dense optical flow at time t.

Through the image generation network 33, predicted image data at time t may be obtained by using the sample reference image and the dense optical flow at time t. The predicted image data serves as the predicted image data matching the sample audio data. The predicted image data is compared with the annotated image data, and the comparison result is used to construct a loss function. The learnable parameters in the model are updated using the loss function to obtain the image generation model. No specific limitation is imposed on hyperparameters, such as the loss function and learning rate. For example, the loss function may employ VGG Perceptual Loss or GAN Loss (adversarial loss). The image generation network simultaneously generates both facial and limb movements for the digital human, improving the rhythmic alignment of the facial and limb movements, thereby enhancing the realism of the digital human. By determining the motion parameters of the predicted keypoints and using the motion parameters of the predicted keypoints for motion estimation to obtain the optical flow of non-key pixel points, the dense optical flow at time t is obtained. The dense optical flow is used as prior motion information for image prediction. By utilizing the sample reference image and the dense optical flow for image prediction, the difficulty of image prediction is significantly reduced, the efficiency of image prediction is improved, and thus the efficiency of model training is improved.

In the technical solution provided by the present disclosure, the motion parameters of the predicted keypoints are determined, and motion estimation is preformed using the motion parameters of the predicted keypoints to obtain the optical flow of non-key pixel points, that is, to obtain dense optical flow; the predicted image data is generated using the sample reference image and dense optical flow; model training is performed by using the predicted image data and annotated image data to obtain an image generation model. By using dense optical flow as prior motion information for image generation, the difficulty of image prediction is significantly reduced, the efficiency of image prediction is improved, and thus the efficiency of model training is improved.

In an optional embodiment, performing, based on the model to be trained, motion estimation using the sample audio data and the reference keypoints to obtain the predicted keypoints that match the sample audio data includes encoding the sample audio data based on the model to be trained to obtain an audio feature; and performing motion estimation using the reference keypoints and the audio feature to obtain the predicted keypoints that match the sample audio data.

The motion estimation network 11 may include an audio encoder and a motion estimation unit. In an embodiment, the sample audio data at time t may be input into the audio encoder to obtain an audio feature. The audio feature and the reference keypoints are input into the motion estimation unit to obtain the predicted keypoints at time t. No specific limitation is imposed on the network structures of the audio encoder and the motion estimation unit. For example, the audio feature may be a traditional audio feature such as mel-frequency cepstral coefficients (MFCCs) or a feature based on deep learning, such as a feature based on the Wav2 Vec 2.0 network; the motion estimation unit may utilize networks such as ResNet (Residual Network), U-Net (U-shaped Network), or Transformer. By combining the audio feature and reference keypoints for motion estimation, the predicted keypoints at time t are obtained. The predicted keypoints include lip keypoints and limb movement keypoints. Thus, not only are the predicted keypoints match the sample audio data, but also the lip movements match limb movements, thereby further improving the quality of image generation.

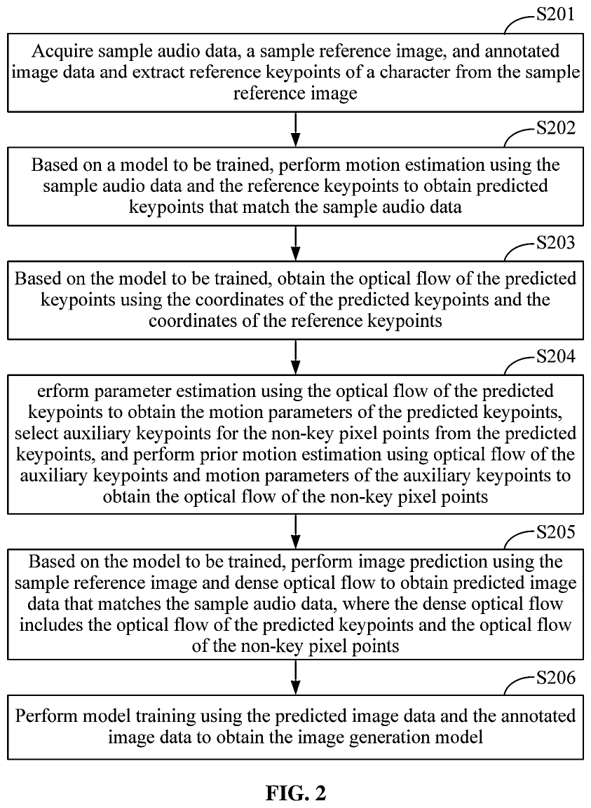

FIG. 2 is another flowchart of the training method for an image generation model according to an embodiment of the present disclosure. As shown in FIG. 2, the training method for an image generation model provided by the embodiment may include S201 to S206.

In S201, sample audio data, a sample reference image, and annotated image data are acquired, and reference keypoints of a character are abstracted from the sample reference image.

In S202, based on a model to be trained, motion estimation is performed using the sample audio data and the reference keypoints to obtain predicted keypoints that match the sample audio data.

In S203, based on the model to be trained, the optical flow of the predicted keypoints is obtained using the coordinates of the predicted keypoints and the coordinates of the reference keypoints.

In S204, parameter estimation is performed using the optical flow of the predicted keypoints to obtain the motion parameters of the predicted keypoints, auxiliary keypoints for the non-key pixel points are selected from the predicted keypoints, and prior motion estimation is performed using optical flow of the auxiliary keypoints and motion parameters of the auxiliary keypoints to obtain the optical flow of the non-key pixel points.

In S205, based on the model to be trained, image prediction is performed using the sample reference image and dense optical flow to obtain predicted image data that matches the sample audio data, where the dense optical flow includes the optical flow of the predicted keypoints and the optical flow of the non-key pixel points.

In S206, model training is performed using the predicted image data and the annotated image data to obtain the image generation model.

The model to be trained may include a motion estimation network, a parameter estimation network, and an image generation network. Through the motion estimation network, motion estimation may be performed using the sample audio data at time t and reference keypoints to obtain predicted keypoints at time t. Through the parameter estimation network, the sparse optical flow of the predicted keypoints may be obtained using the coordinates of the predicted keypoints and the coordinates of the reference keypoints.

$${V}_{Lmk} = {Lmk}_{t} - {Lmk}_{ref} .$$

In the formula, V_{Lmk} denotes the sparse optical flow of the predicted keypoints, and Lmkₜ and Lmk_{ref} denote the coordinates of the predicted keypoints and the coordinates of reference keypoints, respectively.

The motion parameters of the predicted keypoints are used to characterize the influence of the predicted keypoints on the motion of surrounding non-key pixel points. Through the parameter estimation network, the optical flow of the predicted keypoints is also used for parameter estimation to obtain the motion parameters of the predicted keypoints. For a non-key pixel point p with coordinates (xₚ, yₚ), an auxiliary keypoint is selected for the non-key pixel point from the predicted keypoints. For example, the distances between the non-key pixel point and the predicted keypoints may be determined, and a predicted keypoint with a closer distance may be selected as an auxiliary keypoint, such as the nearest predicted keypoint is selected as the auxiliary keypoint. The optical flow and motion parameters of the auxiliary keypoint are used to perform motion estimation to obtain the optical flow of the non-key pixel point. By selecting auxiliary keypoints for non-key pixel points and performing prior motion estimation using the optical flow and motion parameters of the auxiliary keypoints to obtain the optical flow of non-key pixel points, the accuracy of the optical flow of non-key pixel points is enhanced, thereby improving the quality of model learning.

In an optional embodiment, performing parameter estimation using the optical flow of the predicted keypoints to obtain the motion parameters of the predicted keypoints, selecting the auxiliary keypoints for the non-key pixel points from the predicted keypoints, and performing prior motion estimation using the optical flow of the auxiliary keypoints and the motion parameters of the auxiliary keypoints to obtain the optical flow of the non-key pixel points include: determining a motion function obeyed by the predicted keypoints using the optical flow of the predicted keypoints, and taking a derivative of the motion function based on the Taylor distribution to obtain a first-order partial derivative and a second-order partial derivative of the predicted keypoints in a horizontal direction and a vertical direction; and performing prior motion estimation using the coordinates of the non-key pixel points, the coordinates of the auxiliary keypoints, and a first-order partial derivative and a second-order partial derivative of the auxiliary keypoints in the horizontal direction and the vertical direction to obtain the optical flow of the non-key pixel points.

Based on the motion estimation network, the motion function obeyed by the predicted keypoints is determined using the optical flow of the predicted keypoints. The motion function is then derived using the Taylor distribution to obtain the partial derivatives of the predicted keypoints as the motion parameters of the predicted keypoints. The motion parameters of the auxiliary keypoints are then used for motion estimation to obtain the optical flow of the non-key pixel points. By expanding the motion function based on the Taylor distribution, the motion parameters of the auxiliary keypoints are obtained, and the parameters of the auxiliary keypoints are used to determine the optical flow of the non-key pixel points. In this manner, the motion between the predicted keypoints and the non-key pixel points follows the same distribution and lies on the same motion curve. As a result, consistency and correlation of local motion exist between the predicted keypoints and the non-key pixel points. For example, the optical flow of the palm and the optical flow of keypoints within the hand exhibit local consistency such that during the process of spreading the hands, the entire palm and wrist for a same hand move in the same direction. Based on the consistency and correlation of local motion, motion estimation is performed using the partial derivatives of the auxiliary keypoints to obtain the optical flow of the non-key pixel points, thereby improving the accuracy of motion estimation, that is, enhancing the quality of the dense optical flow. Subsequently, introducing the local consistency and correlation of the motion as prior knowledge into the image generation process significantly reduces the difficulty of model learning, thereby improving the efficiency of model training.

In an embodiment, prior motion estimation may be performed using the coordinates of the non-key pixel points, the coordinates of the auxiliary keypoints, and a first-order partial derivative and a second-order partial derivative of the auxiliary keypoints in the horizontal direction and the vertical direction to obtain the optical flow of the non-key pixel points:

$${V}_{p}^{1} \approx {V}_{Lmk}^{i} + \frac{\partial f}{\partial x} {\vert}_{{Lmk}_{t}^{i}} \times ( {x}_{p} - {Lmk}_{{t}_{x}}^{i} ) + \frac{\partial f}{\partial y} {\vert}_{{Lmk}_{t}^{i}} \times ( {y}_{p} - {Lmk}_{{t}_{y}}^{i} ) + \frac{1}{2} \times \frac{{\partial }^{2} f}{\partial {x}^{2}} {\vert}_{{Lmk}_{t}^{i}} \times {( {x}_{p} - {Lmk}_{{t}_{x}}^{i} )}^{2} + \frac{1}{2} \times \frac{{\partial }^{2} f}{\partial {y}^{2}} {\vert}_{{Lmk}_{t}^{i}} \times {( {y}_{p} - {Lmk}_{{t}_{y}}^{i} )}^{2} + \frac{{\partial }^{2} f}{\partial x \partial y} {\vert}_{{Lmk}_{t}^{i}} \times ( {x}_{p} - {Lmk}_{{t}_{x}}^{i} ) \times ( {y}_{p} - {Lmk}_{{t}_{y}}^{i} ) .$$

In the formula, Vₚ¹ and V_{Lmk}ⁱ denote the optical flow of an auxiliary keypoint and the optical flow of a non-key pixel point, respectively, (xₚ, yₚ) denote the coordinates of the non-key pixel point, (Lmkₜₓⁱ, Lmk_{ty}ⁱ) denote the coordinates of the i-th auxiliary keypoint,

$$\frac{\partial f}{\partial x} ∈ and \frac{\partial f}{\partial y} ∈$$

denote the first-order partial derivatives of the auxiliary keypoint moving in the horizontal direction and the vertical direction,

$$\frac{{\partial }^{2} f}{\partial {x}^{2}} ∈ , \frac{{\partial }^{2} f}{\partial {y}^{2}} ∈ , and \frac{{\partial }^{2} f}{\partial x \partial y} ∈$$

denote the second-order partial derivatives of the auxiliary keypoint moving in the horizontal direction and the vertical direction, and |Lmkₜⁱ denotes the value at the auxiliary keypoint Lmkₜⁱ.

In an optional embodiment, after obtaining the optical flow of the non-key pixel points, the method also includes determining the influence weight of the auxiliary keypoints on the non-key pixel points based on the Gaussian distribution, by using the coordinates of the non-key pixel points, the coordinates of the auxiliary keypoints, and a learnable influence radius; and scaling the optical flow of the non-key pixel points using the influence weight of the auxiliary keypoints on the non-key pixel points to obtain scaled optical flow of the non-key pixel points.

The influence radius is used to characterize the degree to which a non-key pixel point is influenced by an auxiliary keypoint. The degree of influence decays as the influence radius increases. In an embodiment, the influence weight of an auxiliary keypoint on a non-key pixel point may be determined through the following formula:

$$W ( p , {Lmk}_{t}^{i} ) = {e}^{- \frac{{( {x}_{p} - {Lmk}_{{t}_{x}}^{i} )}^{2} + {( {y}_{p} - {Lmk}_{{t}_{y}}^{i} )}^{2}}{2 {σ}_{t}^{{i}^{2}}}} .$$

In the formula, W(p, Lmkₜⁱ) denotes the influence weight of the i-th auxiliary keypoint on the non-key pixel p, σₜⁱ denotes the influence radius of the i-th auxiliary keypoint, the influence weight is 1 when p=Lmkₜⁱ, and the farther the non-key pixel point is from the auxiliary keypoint, the smaller the value of the influence weight is. The influence radius, as a learnable parameter, is updated during the model training process. The optical flow is scaled using the influence weight through the following formula:

$${V}_{p}^{2} = W ( p , {Lmk}_{t}^{i} ) \times {V}_{p}^{1} .$$

In the formula, Vₚ¹ and Vₚ² denote the optical flow before scaling and the optical flow after scaling, respectively, and W(p, Lmkₜⁱ) denotes the influence weight. By adopting the Gaussian distribution to determine the influence weight of an auxiliary keypoint on a non-key pixel point, the attenuation amplitude obtained by using the influence weight better matches the actual attenuation amplitude of motion trends compared to a linear decay relationship, thereby further improving the accuracy of the optical flow for non-key pixel points.

In an optional embodiment, after obtaining the optical flow of the non-key pixel points, the method also includes correcting the optical flow of the non-key pixel points using a learnable optical flow offset to obtain corrected optical flow of the non-key pixel points.

In the embodiment of the present disclosure, a learnable optical flow offset is introduced, and the initial value of the optical flow offset is (0, 0). The optical flow of the non-key pixel points is corrected using a learnable optical flow offset through the following formula:

$${V}_{p} = {V}_{p}^{′} + {V}_{p}^{3} .$$

In the formula, Vₚ, V′ₚ, and Vₚ³ denote the corrected optical flow of the non-key pixel point, the optical flow before correction, and a learnable optical flow offset, respectively. The optical flow before correction may be Vₚ¹ or Vₚ². Local motion may not always be in the same direction. For example, the five fingers of a hand may move in different directions. By introducing a learnable optical flow offset, the diversity of local motion is increased, thus further enhancing the accuracy of the optical flow.

The technical solution provided by the embodiment of the present disclosure introduces the following into the model learning process as prior knowledge: local motion consistency and correlation based on second-order Taylor expansion, introduces the attenuation of the motion trend as prior knowledge into the model learning process based on the Gaussian distribution, and introduces motion diversity into the model learning process based on learnable offsets. In this manner, the difficulty of model learning is significantly reduced, training efficiency of the model is improved, and the accuracy of optical flow is enhanced, thereby improving the quality of image generation.

In an optional embodiment, performing, based on the model to be trained, image prediction using the sample reference image and the dense optical flow to obtain the predicted image data that matches the sample audio data includes: masking the dense optical flow based on the model to be trained to obtain masked dense optical flow; and performing image prediction using the sample reference image and the masked dense optical flow to obtain the predicted image data that matches the sample audio data.

In the embodiment of the present disclosure, dense optical flow may also be randomly masked through the following formula:

$${V}_{mask}^{j} = \{ \begin{matrix}( 0 , 0 ) , & u > 0.9 \\ {V}^{j} , & u \leq 0. 9\end{matrix} .$$

In the formula, Vₘₐₛₖ^{j} denotes the j-th value of Vₘₐₛₖ, and V^{j} denotes the j-th value of V. u denotes a value randomly sampled from a uniform distribution [0, 1]. By introducing motion prior knowledge into the model learning process, the difficulty of model learning is significantly reduced. Applying random masking to the dense optical flow decreases the amount of information available to the model, increasing the learning difficulty. This process helps prevent overfitting caused by the introduction of prior knowledge, thereby enhancing the robustness of the model.

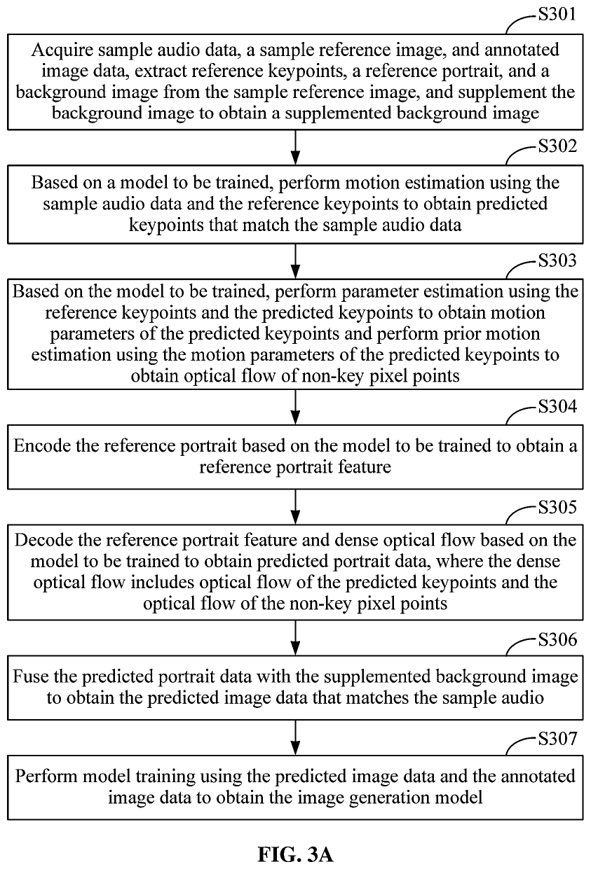

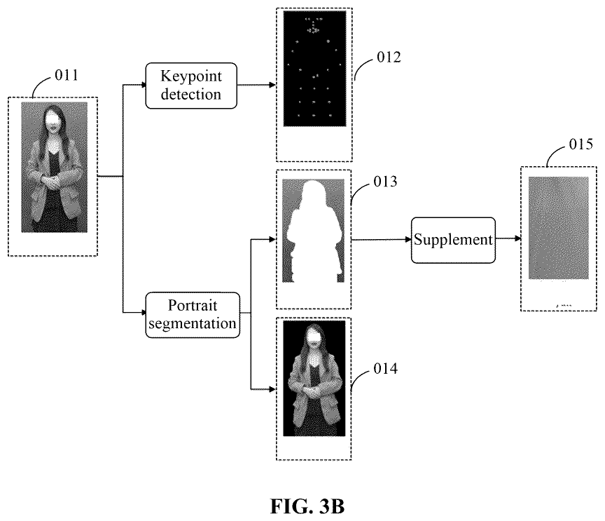

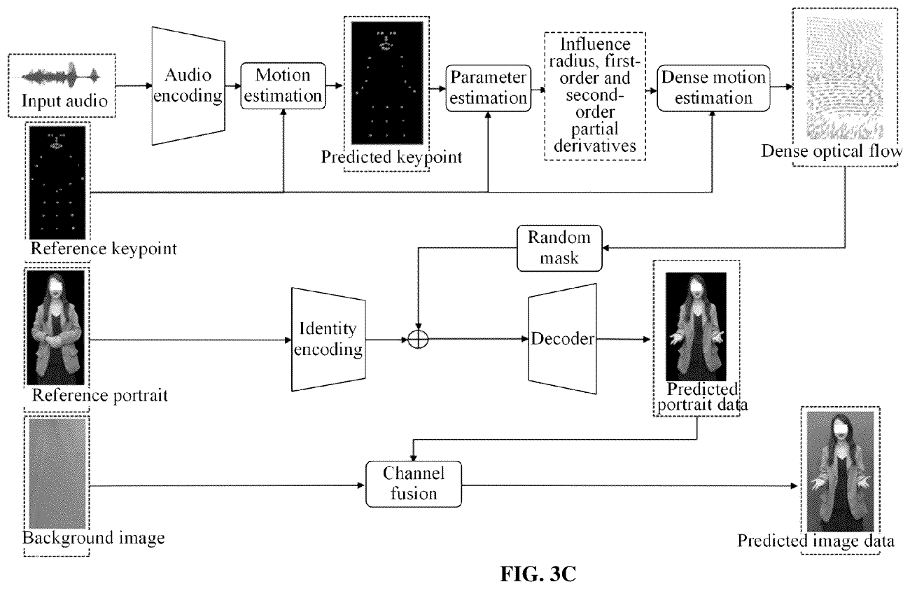

FIG. 3A is still another flowchart of the training method for an image generation model according to an embodiment of the present disclosure. As shown in FIG. 3A, the training method for an image generation model provided by the embodiment may include S301 to S307.

In S301, sample audio data, a sample reference image, and annotated image data are acquired, reference keypoints, a reference portrait, and a background image are extracted from the sample reference image, and the background image is supplemented to obtain a supplemented background image.

In S302, based on a model to be trained, motion estimation is performed using the sample audio data and the reference keypoints to obtain predicted keypoints that match the sample audio data.

In S303, based on the model to be trained, parameter estimation is performed using the reference keypoints and the predicted keypoints to obtain motion parameters of the predicted keypoints, and prior motion estimation is performed using the motion parameters of the predicted keypoints to obtain optical flow of non-key pixel points.

In S304, the reference portrait is encoded based on the model to be trained to obtain a reference portrait feature.

In S305, the reference portrait feature and dense optical flow are decoded based on the model to be trained to obtain predicted portrait data, where the dense optical flow includes optical flow of the predicted keypoints and the optical flow of the non-key pixel points.

In S306, the predicted portrait data is fused with the supplemented background image to obtain the predicted image data that matches the sample audio.

In S307, model training is performed using the predicted image data and the annotated image data to obtain the image generation model.

With reference to 3B, reference keypoints 012 are extracted from the sample reference image 011 through keypoint detection, the sample reference image 011 undergoes portrait segmentation to obtain a reference portrait 014 and a background image 013, and the background image 013 is then supplemented to generate a supplemented background image 015. By separating the foreground reference portrait and the background image, the learning process of the model only focuses on the foreground portrait while ignoring the background. In this manner, not only the difficulty of model learning is reduced, but also unnatural transitions between the portrait and background in the predicted image data are avoided by fusing the generated predicted portrait data with the supplemented background image to obtain predicted image data.

An audio feature is obtained by performing audio encoding on the sample audio data at time t. The audio feature and the reference keypoints are input into the motion estimation network to obtain predicted keypoints at time t. The predicted keypoints and reference keypoints are input into the parameter estimation network to obtain the motion parameters of the predicted keypoints. Using the motion parameters of the predicted keypoints, the optical flow of non-key pixel points is estimated, thereby obtaining dense optical flow. The reference portrait is input into the corresponding encoder to generate a reference portrait feature. The reference portrait feature and the dense optical flow are input into the image generation network to obtain predicted portrait data at time t. The predicted portrait data and the supplemented background image are fused to obtain predicted image data at time t.

In the embodiment of the present disclosure, the alpha channel for completely black part in the predicted portrait data is set to 0, while the alpha channel for non-completely black part is set to 1, and the predicted portrait data and the supplemented background image are then fused based on the alpha channel to achieve a background overlay effect. In an embodiment, the fusion of foreground and background may be performed through the following formula:

$$R ( C ) = alpha \times R ( B ) + ( 1 - alpha ) \times R ( A ) .$$

In the formula, R(C), R(B), and R(A) denote the fusion color value in the predicted image data, the background color value in the supplemented background image, and the foreground color value in the predicted portrait data, respectively, and alpha denotes the transparency of the foreground. The alpha channel is used to represent pixel transparency, typically ranging from 0 to 255, where 0 represents complete transparency and 255 represents complete opacity. By fusing the generated predicted portrait data with the supplemented background image, natural transitions are achieved at the edges of the portrait and the background, thereby improving the quality of image generation.

In an optional embodiment, performing, based on the model to be trained, image prediction using the sample reference image and the dense optical flow to obtain the predicted image data that matches the sample audio data includes: masking the dense optical flow based on the model to be trained to obtain masked dense optical flow; and performing image prediction using the sample reference image and the masked dense optical flow to obtain the predicted image data that matches the sample audio data.

In the embodiment of the present disclosure, the dense optical flow is also randomly masked to obtain masked dense optical flow, and image prediction is performed using the sample reference image and the masked dense optical flow to obtain the predicted image data that matches the sample audio data. In an embodiment, the reference portrait is input into a portrait encoder to obtain a reference portrait feature. The reference portrait feature and the masked dense optical flow are input into the image generation network to obtain predicted portrait data at time t. In addition, the predicted portrait data and the supplemented background image are fused to obtain predicted image data. Applying random masking to the dense optical flow decreases the amount of information available to the model, thereby increasing the learning difficulty and enhancing the robustness of the model.

With reference to 3C, during the training stage, sample audio data may be input into an audio encoder to obtain an audio feature, the reference keypoints and audio feature are input into the motion estimation network to obtain predicted keypoints, the reference keypoints and predicted keypoints are input into the parameter estimation network to obtain the motion parameters of the predicted keypoints, such as influence radius, first- and second-order partial derivatives, and using the coordinates of the reference keypoints, the coordinates of the predicted keypoints, and the motion parameters of the predicted keypoints, a second-order prior dense motion estimation is performed to obtain dense optical flow. The dense optical flow is randomly masked to obtain masked dense optical flow. In addition, the reference portrait undergoes identity encoding to obtain a reference portrait feature. The reference portrait feature and the masked dense optical flow are input into the decoder to obtain predicted portrait data. The supplemented background image and the predicted portrait data are fused using the alpha channel to obtain predicted image data.

The technical solution provided by the embodiment of the present disclosure determines the motion parameters of the predicted keypoints and uses the motion parameters of the predicted keypoints to perform motion estimation to obtain the optical flow of non-key pixel points, thereby obtaining dense optical flow. The dense optical flow is introduced as prior knowledge into the image generation process, improving the efficiency of image generation. The method proposes a training method for an image generation model based on second-order motion prior. Through learning, a digital human matching the audio data can be generated, and the alignment of facial expressions and limb movements of the digital human with the audio data is improved.

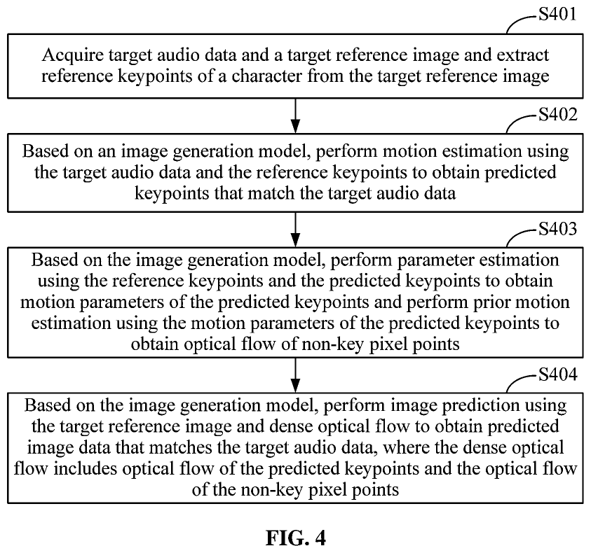

FIG. 4 is a flowchart of an image generation method according to an embodiment of the present disclosure. The method is applicable to the case of generating matching image data for audio data. The method may be performed by an image generation apparatus. The apparatus may be implemented by software and/or hardware and may be integrated into an electronic device. As shown in FIG. 4, the image generation method of this embodiment may include S401 to S404.

In S401, target audio data and a target reference image are acquired, and reference keypoints of a character are extracted from the target reference image.

In S402, based on an image generation model, motion estimation is performed using the target audio data and the reference keypoints to obtain predicted keypoints that match the target audio data.

In S403, based on the image generation model, parameter estimation is performed using the reference keypoints and the predicted keypoints to obtain motion parameters of the predicted keypoints, and prior motion estimation is performed using the motion parameters of the predicted keypoints to obtain optical flow of non-key pixel points.

In S404, based on the image generation model, image prediction is performed using the target reference image and dense optical flow to obtain predicted image data that matches the target audio data, where the dense optical flow includes optical flow of the predicted keypoints and the optical flow of the non-key pixel points.

The embodiment of the present disclosure proposes an image generation model based on motion prior. By introducing prior information about motion, the learning difficulty of the model is significantly reduced, and the efficiency of image generation is improved. The image generation model is used to generate digital human images that match audio so that the facial expressions and limb movements of the digital human images, particularly lip movements, match the audio. The input to the image generation model is continuous audio data and reference images, while the output is a video with coherent lip and limb movements. The movement of the character in the video matches the audio.

The input target audio data and target reference image are acquired, and the target reference image may be preprocessed to obtain the reference keypoints of a character in the target reference image. In an embodiment, keypoint detection may be performed on the target reference image to obtain the reference keypoints. The reference keypoints are used to provide the initial position of the character so that the model knows the approximate spatial positions of the character's face, limbs, and other parts of the body, thereby improving the quality of image generation.

The image generation model may include a motion estimation network, a parameter estimation network, and an image generation network. The motion estimation network may be used to predict keypoints (predicted keypoints) at time t based on the target audio data at time t and reference keypoints. The reference keypoints and predicted keypoints at time t are then input into the parameter estimation network to obtain the motion parameters of the predicted keypoints at time t. The motion parameters of the predicted keypoints are used for prior motion estimation to obtain the optical flow of non-key pixel points, that is, to obtain the optical flow of ordinary pixel points around the predicted keypoints. The motion parameters of the predicted keypoints include both the optical flow of the predicted keypoints and the influence parameters of the predicted keypoints on surrounding pixel points. The optical flow of each predicted keypoint and the optical flow of each non-key pixel point may form the dense optical flow at time t.

Through the image generation network, the target reference image and the dense optical flow at time t can be used to obtain the predicted image data at time t as the predicted image data matching the target audio data. By determining the motion parameters of the predicted keypoints and using the motion parameters of the predicted keypoints for motion estimation to obtain the optical flow of non-key pixel points, the dense optical flow at time t is obtained. The dense optical flow is used as prior motion information for image prediction. By utilizing the target reference image and the dense optical flow for image prediction, the difficulty of image prediction is significantly reduced, and the efficiency of image prediction is improved.

In the technical solution provided by the embodiment of the present disclosure, the motion parameters of the predicted keypoints are determined, and motion estimation is preformed using the motion parameters of the predicted keypoints to obtain the optical flow of non-key pixel points, that is, to obtain dense optical flow; the predicted image data is generated using the target reference image and dense optical flow, that is, by using dense optical flow as prior motion information for image generation, the difficulty of image prediction is significantly reduced, and the efficiency of image prediction is improved.

In an optional embodiment, performing, based on the image generation model, motion estimation using the target audio data and the reference keypoints to obtain the predicted keypoints that match the target audio data includes: encoding the target audio data based on the image generation model to obtain an audio feature; and performing motion estimation using the reference keypoints and the audio feature to obtain the predicted keypoints that match the target audio data.

The motion estimation network may include an audio encoder and a motion estimation unit. In an embodiment, the target audio data at time t may be input into the audio encoder to obtain an audio feature. The audio feature and the reference keypoints are input into the motion estimation unit to obtain the predicted keypoints at time t. The predicted keypoints at time t are obtained by combining the audio feature and the reference keypoints for motion estimation so that the predicted keypoints match the target audio data, thereby improving the alignment between the subsequent predicted image data and the target audio data.

In an optional embodiment, the method also includes acquiring keypoints of a customized action; and fusing the keypoints of the customized action with the predicted keypoints that match the target audio data to obtain new predicted keypoints.

Additionally, a user-defined action keypoint sequence is supported. In an embodiment, user-defined action keypoints are acquired, and the keypoints of the customized action are fused with the predicted keypoints to obtain new predicted keypoints. For example, user-defined limb movement keypoints may be acquired, and the predicted lip-syncing keypoints matching the target audio data may be used to supplement the user-defined limb movement keypoints to obtain new predicted keypoints. In this manner, it is ensured that the new predicted keypoints balance the flexibility of limb movements with the consistency and smoothness of lip-syncing. Subsequently, the new predicted keypoints are used to determine the dense optical flow.

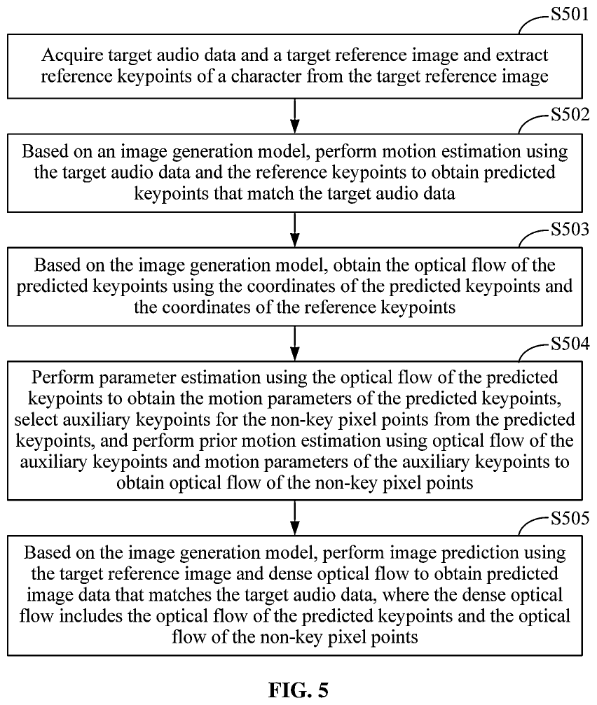

FIG. 5 is a flowchart of an image generation method according to an embodiment of the present disclosure. As shown in FIG. 5, the image generation method of this embodiment may include S501 to S505.

In S501, target audio data and a target reference image are acquired, and reference keypoints of a character are extracted from the target reference image.

In S502, based on an image generation model, motion estimation is performed using the target audio data and the reference keypoints to obtain predicted keypoints that match the target audio data.

In S503, based on the image generation model, the optical flow of the predicted keypoints is obtained using the coordinates of the predicted keypoints and the coordinates of the reference keypoints.

In S504, parameter estimation is performed using the optical flow of the predicted keypoints to obtain the motion parameters of the predicted keypoints, auxiliary keypoints for the non-key pixel points are selected from the predicted keypoints, and prior motion estimation is performed using optical flow of the auxiliary keypoints and motion parameters of the auxiliary keypoints to obtain optical flow of the non-key pixel points.

In S505, based on the image generation model, image prediction is performed using the target reference image and dense optical flow to obtain predicted image data that matches the target audio data, where the dense optical flow includes optical flow of the predicted keypoints and the optical flow of the non-key pixel points.

An image generation module may include a motion estimation network, a parameter estimation network, and an image generation network. Through the motion estimation network, motion estimation may be performed using the target audio data at time t and reference keypoints to obtain predicted keypoints at time t. Through the parameter estimation network, the sparse optical flow of the predicted keypoints may be obtained using the coordinates of the predicted keypoints and the coordinates of the reference keypoints.

$${V}_{Lmk} = {Lmk}_{t} - {Lmk}_{ref} .$$

In the formula, V_{Lmk} denotes the sparse optical flow of the predicted keypoints, and Lmkₜ and Lmk_{ref} denote the coordinates of the predicted keypoints and the coordinates of the reference keypoints, respectively.

The motion parameters of the predicted keypoints are used to characterize the influence of the predicted keypoints on the motion of surrounding non-key pixel points. Through the parameter estimation network, the optical flow of the predicted keypoints is also used for parameter estimation to obtain the motion parameters of the predicted keypoints. For a non-key pixel point p with coordinates (xₚ, yₚ), an auxiliary keypoint is selected for the non-key pixel point from the predicted keypoints. For example, the distances between the non-key pixel point and the predicted keypoints may be determined, and a predicted keypoint with a closer distance may be selected as an auxiliary keypoint. The optical flow and motion parameters of the auxiliary keypoint are used to perform motion estimation to obtain the optical flow of the non-key pixel point. By selecting auxiliary keypoints for non-key pixel points and performing prior motion estimation using the optical flow and motion parameters of the auxiliary keypoints to obtain the optical flow of non-key pixel points, the accuracy of the optical flow of non-key pixel points is enhanced, thereby improving the quality of model learning.

In an optional embodiment, performing parameter estimation using the optical flow of the predicted keypoints to obtain the motion parameters of the predicted keypoints, selecting the auxiliary keypoints for the non-key pixel points from the predicted keypoints, and performing prior motion estimation using the optical flow of the auxiliary keypoints and the motion parameters of the auxiliary keypoints to obtain the optical flow of the non-key pixel points include: determining a motion function obeyed by the predicted keypoints using the optical flow of the predicted keypoints, and taking a derivative of the motion function based on the Taylor distribution to obtain a first-order partial derivative and a second-order partial derivative of the predicted keypoints in a horizontal direction and a vertical direction; and performing prior motion estimation using the coordinates of the non-key pixel points, the coordinates of the auxiliary keypoints, and a first-order partial derivative and a second-order partial derivative of the auxiliary keypoints in the horizontal direction and the vertical direction to obtain the optical flow of the non-key pixel points.

Based on the motion estimation network, the motion function obeyed by the predicted keypoints is determined using the optical flow of the predicted keypoints. The motion function is then derived using the Taylor distribution to obtain the partial derivatives of the predicted keypoints as the motion parameters of the predicted keypoints. The motion parameters of the auxiliary keypoints are then used for motion estimation to obtain the optical flow of the non-key pixel points. By expanding the motion function based on the Taylor distribution, the motion parameters of the auxiliary keypoints are obtained, and the parameters of the auxiliary keypoints are used to determine the optical flow of the non-key pixel points. In this manner, the motion between the predicted keypoints and the non-key pixel points follows the same distribution and lies on the same motion curve. As a result, consistency and correlation of local motion exist between the predicted keypoints and the non-key pixel points. For example, the optical flow of the palm and the optical flow of keypoints within the hand exhibit local consistency such that during the process of spreading the hands, the entire palm and wrist move in the same direction. Based on the consistency and correlation of local motion, motion estimation is performed using the partial derivatives of the auxiliary keypoints to obtain the optical flow of the non-key pixel points, thereby improving the accuracy of motion estimation, that is, enhancing the quality of the dense optical flow. Subsequently, introducing the local consistency and correlation of the motion as prior knowledge into the image generation process significantly reduces the difficulty of model learning, thereby improving the efficiency of model training.

In an embodiment, prior motion estimation may be performed using the coordinates of the non-key pixel points, the coordinates of the auxiliary keypoints, and a first-order partial derivative and a second-order partial derivative of the auxiliary keypoints in the horizontal direction and the vertical direction to obtain the optical flow of the non-key pixel points.

$${V}_{p}^{1} \approx {V}_{Lmk}^{i} + \frac{\partial f}{\partial x} {\vert}_{{Lmk}_{t}^{i}} \times ( {x}_{p} - {Lmk}_{{t}_{x}}^{i} ) + \frac{\partial f}{\partial y} {\vert}_{{Lmk}_{t}^{i}} \times ( {y}_{p} - {Lmk}_{{t}_{y}}^{i} ) + \frac{1}{2} \times \frac{{\partial }^{2} f}{\partial {x}^{2}} {\vert}_{{Lmk}_{t}^{i}} \times {( {x}_{p} - {Lmk}_{{t}_{x}}^{i} )}^{2} + \frac{1}{2} \times \frac{{\partial }^{2} f}{\partial {y}^{2}} {\vert}_{{Lmk}_{t}^{i}} \times {( {y}_{p} - {Lmk}_{{t}_{y}}^{i} )}^{2} + \frac{{\partial }^{2} f}{\partial x \partial y} {\vert}_{{Lmk}_{t}^{i}} \times ( {x}_{p} - {Lmk}_{{t}_{x}}^{i} ) \times ( {y}_{p} - {Lmk}_{{t}_{y}}^{i} ) .$$

In the formula, Vₚ¹ and V_{Lmk}ⁱ denote the optical flow of an auxiliary keypoint and the optical flow of a non-key pixel point, respectively, (xₚ, yₚ) denote the coordinates of the non-key pixel point, (Lmkₜₓⁱ, Lmk_{ty}ⁱ) denote the coordinates of the i-th auxiliary keypoint.

$$\frac{\partial f}{\partial x} ∈ and \frac{\partial f}{\partial y} ∈$$

denote the first-order partial derivatives of the auxiliary keypoint moving in the horizontal direction and the vertical direction,

$$\frac{{\partial }^{2} f}{\partial {x}^{2}} ∈ , \frac{{\partial }^{2} f}{\partial {y}^{2}} ∈ , and \frac{{\partial }^{2} f}{\partial x \partial y} ∈$$

denote the second-order partial derivatives of the auxiliary keypoint moving in the horizontal direction and the vertical direction, and |Lmkₜⁱ denotes the value at the auxiliary keypoint Lmkₜⁱ.

In an optional embodiment, after obtaining the optical flow of the non-key pixel points, the method also includes determining the influence weight of the auxiliary keypoints on the non-key pixel points based on the Gaussian distribution, by using the coordinates of the non-key pixel points, the coordinates of the auxiliary keypoints, and a learnable influence radius; and scaling the optical flow of the non-key pixel points using the influence weight of the auxiliary keypoints on the non-key pixel points to obtain scaled optical flow of the non-key pixel points.

The influence radius is used to characterize the degree to which a non-key pixel point is influenced by an auxiliary keypoint. The degree of influence decays as the influence radius increases. In an embodiment, the influence weight of an auxiliary keypoint on a non-key pixel point may be determined through the following formula:

$$W ( p , {Lmk}_{t}^{i} ) = {e}^{- \frac{{( {x}_{p} - {Lmk}_{{t}_{x}}^{i} )}^{2} + {( {y}_{p} - {Lmk}_{{t}_{y}}^{i} )}^{2}}{2 {σ}_{t}^{{i}^{2}}}} .$$

In the formula, W(p, Lmkₜⁱ) denotes the influence weight of the i-th auxiliary keypoint on the non-key pixel p, σₜⁱ denotes the influence radius of the i-th auxiliary keypoint, the influence weight is 1 when p=Lmkₜⁱ, and the farther the non-key pixel point is from the auxiliary keypoint, the smaller the value of the influence weight is. The influence radius, as a learnable parameter, is updated during the model training process. The optical flow is scaled using the influence weight through the following formula:

$${V}_{p}^{2} = W ( p , {Lmk}_{t}^{i} ) \times {V}_{p}^{1}$$

In the formula, Vₚ¹ and Vₚ² denote the optical flow before scaling and the optical flow after scaling, respectively, and W(p, Lmkₜⁱ) denotes the influence weight. By adopting the Gaussian distribution to determine the influence weight of an auxiliary keypoint on a non-key pixel point, the attenuation amplitude obtained by using the influence weight better matches the actual attenuation of motion trends compared to a linear decay relationship, thereby further improving the accuracy of the optical flow for non-key pixel points.

In an optional embodiment, after obtaining the optical flow of the non-key pixel points, the method also includes correcting the optical flow of the non-key pixel points using a learnable optical flow offset to obtain corrected optical flow of the non-key pixel points.

In the embodiment of the present disclosure, a learnable optical flow offset is introduced, and the optical flow of the non-key pixel points is corrected using the learnable optical flow offset through the following formula:

$${V}_{p} = {V}_{p}^{′} + {V}_{p}^{3}$$

In the formula, Vₚ and V′p, Vₚ³ denote the corrected optical flow of the non-key pixel point, the optical flow before correction, and a learnable optical flow offset, respectively. The optical flow before correction may be Vₚ¹ or Vₚ². Local motion may not always be in the same direction. For example, the five fingers of a hand may move in different directions. By introducing a learnable optical flow offset, the diversity of local motion is increased, thus further enhancing the accuracy of the optical flow.

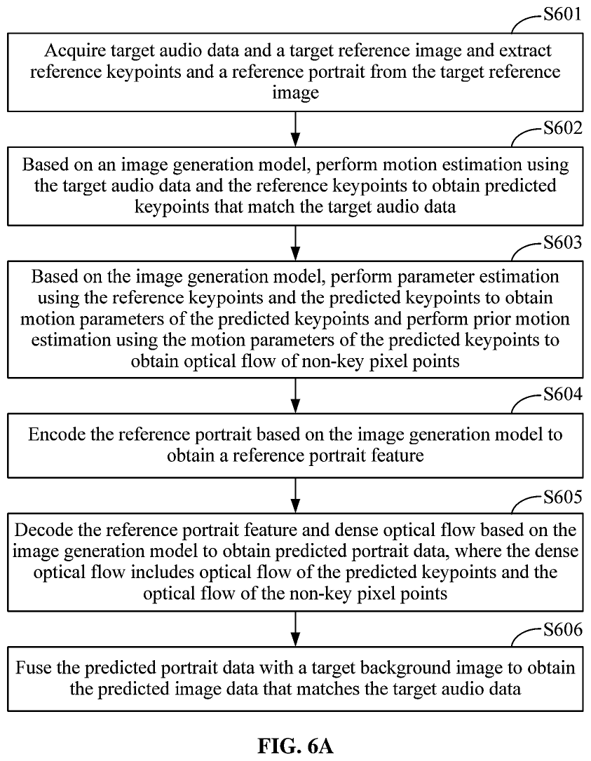

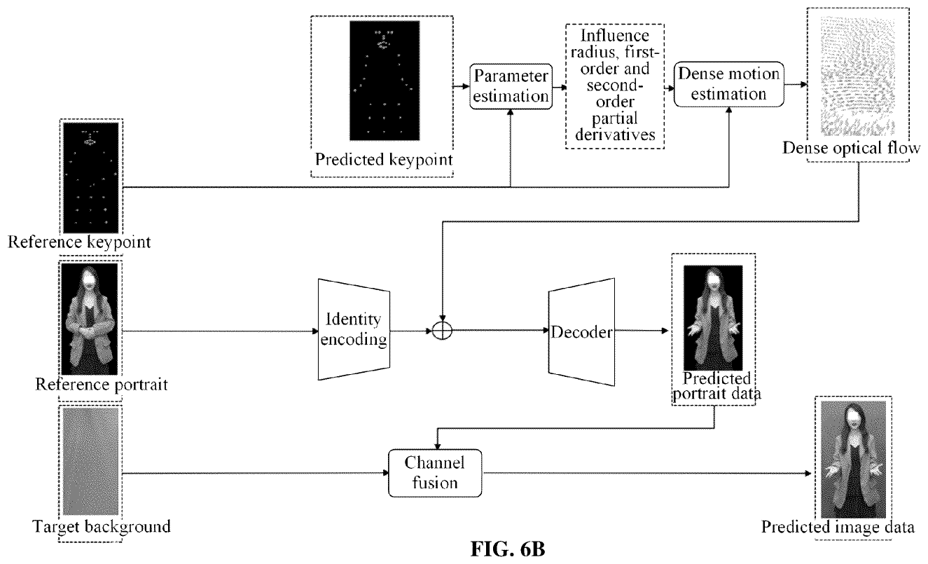

FIG. 6A is still another flowchart of the image generation model according to an embodiment of the present disclosure. As shown in FIG. 6A, the image generation method of this embodiment may include S601 to S606.

In S601, target audio data and a target reference image are acquired, and reference keypoints and a reference portrait are extracted from the target reference image.

In S602, based on an image generation model, motion estimation is performed using the target audio data and the reference keypoints to obtain predicted keypoints that match the target audio data.

In S603, based on the image generation model, parameter estimation is performed using the reference keypoints and the predicted keypoints to obtain motion parameters of the predicted keypoints, and prior motion estimation is performed using the motion parameters of the predicted keypoints to obtain optical flow of non-key pixel points.

In S604, the reference portrait is encoded based on the image generation model to obtain a reference portrait feature.

In S605, the reference portrait feature and dense optical flow are decoded based on the image generation model to obtain predicted portrait data, where the dense optical flow includes optical flow of the predicted keypoints and the optical flow of the non-key pixel points.

In S606, the predicted portrait data is fused with a target background image to obtain the predicted image data that matches the target audio data.

Reference keypoints are extracted from the target reference image through keypoint detection, and the target reference image undergoes portrait segmentation to obtain a reference portrait. By separating the foreground reference portrait and the background image, the prediction process of the model only focuses on the foreground portrait while ignoring the background. In this manner, the difficulty of model learning is reduced.

An audio feature is obtained by performing audio encoding on the target audio data at time t. The audio feature and the reference keypoints are input into the motion estimation network to obtain predicted keypoints at time t. The predicted keypoints and reference keypoints are input into the parameter estimation network to obtain the motion parameters of the predicted keypoints. Using the motion parameters of the predicted keypoints, the optical flow of non-key pixel points is estimated, thereby obtaining dense optical flow. The reference portrait is input into a portrait encoder to obtain a reference portrait feature. The reference portrait feature and the dense optical flow are input into the image generation network to obtain predicted portrait data at time t.

In addition, a target background image is also determined, and the generated predicted portrait data and the target background image are fused to obtain predicted image data. In an embodiment, the alpha channel for completely black part in the predicted portrait data is set to 0, while the alpha channel for non-completely black part is set to 1, and the predicted portrait data and the target background image are then fused based on the alpha channel to achieve a background overlay effect. In an embodiment, the fusion of foreground and background may be performed through the following formula:

$$R ( C ) = alpha \times R ( B ) + ( 1 - alpha ) \times R ( A ) .$$

In the formula, R(C), R(B), and R(A) denote the fusion color value in the predicted image data, the background color value in the target background image, and the foreground color value in the predicted portrait data, respectively, and alpha denotes the transparency of the foreground. The alpha channel is used to represent pixel transparency, typically ranging from 0 to 255, where 0 represents complete transparency and 255 represents complete opacity. By fusing the generated predicted portrait data and the target background image, the efficiency of image generation is improved compared to using a model to predict the background image.

In an optional embodiment, the method also includes extracting a background image from the target reference image, supplementing the extracted background image, and using the supplemented background image as the target background image.

In the process of portrait segmentation of the target reference image, not only the reference portrait but also the background image can be obtained, and the background image is supplemented to obtain the supplemented background image as the target background image. By fusing the generated predicted portrait data with the supplemented background image to obtain the predicted image data, the connectivity between the portrait and the background in the predicted image data can be improved, and the quality of image generation can be further improved.

In an optional embodiment, the method also includes acquiring a customized background image to serve as the target background image.

The embodiment of the present disclosure also supports a customized background image. By using a customized background image as the target background image and fusing the customized background image with the generated predicted portrait data to obtain the predicted image data, the flexibility of image generation can be further enhanced.

With reference to 6B, during the image generation stage, predicted keypoints may be determined and input into the parameter estimation network along with reference keypoints to obtain motion parameters of the predicted keypoints; second-order prior dense motion estimation is performed using the coordinates of the predicted keypoints, the motion parameters of the predicted keypoints, and the coordinates of the reference keypoints to obtain dense optical flow. In addition, the reference portrait undergoes identity encoding to obtain a reference portrait feature. The reference portrait feature and the dense optical flow are input into the decoder to obtain predicted portrait data. The target background image and the predicted portrait data are fused using the alpha channel to obtain predicted image data. It should be noted that during the image generation process, random masking of dense optical flow is not required, and the random masking module in the training process may be removed.

The technical solution provided by the embodiment of the present disclosure determines the motion parameters of the predicted keypoints and uses the motion parameters of the predicted keypoints to perform motion estimation to obtain the optical flow of non-key pixel points, thereby obtaining dense optical flow. The dense optical flow is introduced as prior knowledge into the image generation process, improving the efficiency of image generation. In other words, a method for generating facial expressions and actions of a digital human based on second-order motion prior is proposed. This method enables the simultaneous generation of a digital human's facial expressions and limb movements through an end-to-end network. The method also supports user-defined actions and backgrounds, offering broad application scenarios.

FIG. 7 is a diagram illustrating the structure of a training apparatus for an image generation model according to an embodiment of the present disclosure. This embodiment is applicable to the case where an image generation model is trained based on motion prior. The apparatus may be implemented in software and/or hardware and may be integrated into an electronic device. As shown in FIG. 7, the training apparatus for an image generation model 700 provided by the embodiment may include a reference keypoint module 710, a predicted keypoint module 720, an optical flow estimation module 730, an image prediction module 740, and a model training module 750.

The reference keypoint module 710 is configured to acquire sample audio data, a sample reference image, and annotated image data and extract reference keypoints of a character from the sample reference image.

The predicted keypoint module 720 is configured to: based on a model to be trained, perform motion estimation using the sample audio data and the reference keypoints to obtain predicted keypoints that match the sample audio data.

The optical flow estimation module 730 is configured to: based on the model to be trained, perform parameter estimation using the reference keypoints and the predicted keypoints to obtain motion parameters of the predicted keypoints and perform prior motion estimation using the motion parameters of the predicted keypoints to obtain optical flow of non-key pixel points.

The image prediction module 740 is configured to: based on the model to be trained, perform image prediction using the sample reference image and dense optical flow to obtain predicted image data that matches the sample audio data, where the dense optical flow includes optical flow of the predicted keypoints and the optical flow of the non-key pixel points.

The model training module 750 is configured to perform model training using the predicted image data and the annotated image data to obtain the image generation model.

In an optional embodiment, the optical flow estimation module 730 includes a key optical flow unit and a pixel optical flow unit.

The key optical flow unit is configured to: based on the model to be trained, obtain the optical flow of the predicted keypoints using coordinates of the predicted keypoints and coordinates of the reference keypoints.

The pixel optical flow unit is configured to perform parameter estimation using the optical flow of the predicted keypoints to obtain the motion parameters of the predicted keypoints, select auxiliary keypoints for the non-key pixel points from the predicted keypoints, and perform prior motion estimation using optical flow of the auxiliary keypoints and motion parameters of the auxiliary keypoints to obtain the optical flow of the non-key pixel points.

In an optional embodiment, the pixel optical flow unit includes a first optical flow subunit.

The first optical flow subunit is specifically configured to operate the following: determining a motion function obeyed by the predicted keypoints using the optical flow of the predicted keypoints, and taking a derivative of the motion function based on the Taylor distribution to obtain a first-order partial derivative and a second-order partial derivative of the predicted keypoints in a horizontal direction and a vertical direction; and performing prior motion estimation using coordinates of the non-key pixel points, coordinates of the auxiliary keypoints, and a first-order partial derivative and a second-order partial derivative of the auxiliary keypoints in the horizontal direction and the vertical direction to obtain the optical flow of the non-key pixel points.

In an optional embodiment, the pixel optical flow unit includes a second optical flow subunit.

The second optical flow subunit is specifically configured to operate the following: determining influence weight of the auxiliary keypoints on the non-key pixel points based on the Gaussian distribution, by using the coordinates of the non-key pixel points, the coordinates of the auxiliary keypoints, and a learnable influence radius; and scaling the optical flow of the non-key pixel points using the influence weight of the auxiliary keypoints on the non-key pixel points to obtain scaled optical flow of the non-key pixel points.

In an optional embodiment, the pixel optical flow unit includes a third optical flow subunit.

The third optical flow subunit is specifically configured to operate the following:

correcting the optical flow of the non-key pixel points using a learnable optical flow offset to obtain corrected optical flow of the non-key pixel points.

In an optional embodiment, the reference keypoint module 710 is specifically configured to extract reference keypoints, a reference portrait, and a background image from the sample reference image and supplement the background image to obtain a supplemented background image.

The image prediction module 740 includes a portrait encoding unit, a portrait decoding unit, and a fusion unit.

The portrait encoding unit is configured to encode the reference portrait based on the model to be trained to obtain a reference portrait feature.

The portrait decoding unit is configured to decode the reference portrait feature and the dense optical flow based on the model to be trained to obtain predicted portrait data.

The fusion unit is configured to fuse the predicted portrait data with the supplemented background image to obtain the predicted image data that matches the sample audio data.

In an optional embodiment, the fusion unit is specifically configured to operate the following: masking the dense optical flow based on the model to be trained to obtain masked dense optical flow; and performing image prediction using the sample reference image and the masked dense optical flow to obtain the predicted image data that matches the sample audio data.

In an optional embodiment, the reference keypoint module 710 is specifically configured to operate the following: encoding the sample audio data based on the model to be trained to obtain an audio feature; and performing motion estimation using the reference keypoints and the audio feature to obtain the predicted keypoints that match the sample audio data.

The technical solutions provided by the embodiments of the present disclosure determine the motion parameters of the predicted keypoints and use the motion parameters of the predicted keypoints to perform motion estimation to obtain the optical flow of non-key pixel points, thereby obtaining dense optical flow. The dense optical flow is introduced as prior knowledge into the image generation process, improving the efficiency of image generation. The method proposes a training method for an image generation model based on second-order motion prior. Through learning, a digital human matching the audio data can be generated, and the alignment of facial expressions and limb movements of the digital human with the audio data is improved.

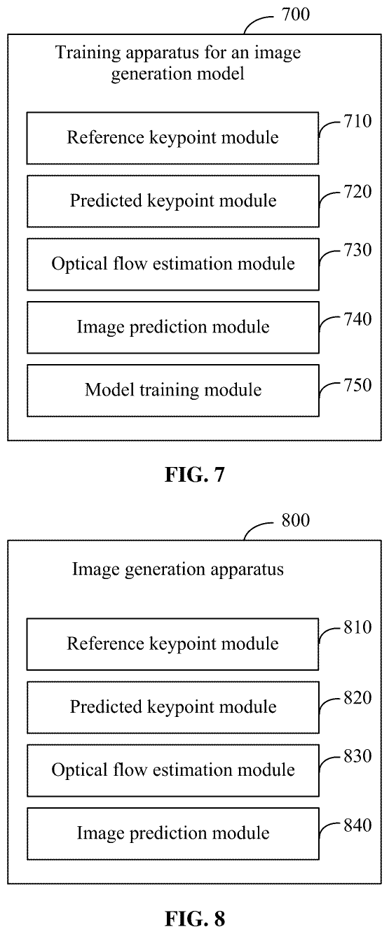

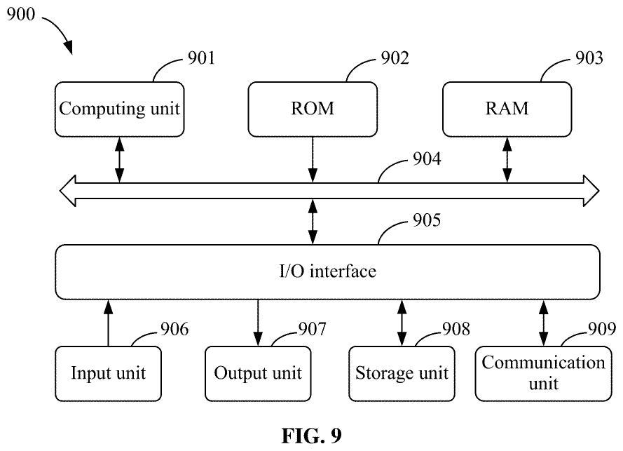

FIG. 8 is a diagram illustrating the structure of an image generation apparatus according to an embodiment of the present disclosure. The embodiment is applicable to the case of generating matching image data for audio data. The apparatus may be implemented in software and/or hardware and may be integrated into an electronic device. As shown in FIG. 8, the image generation apparatus 800 provided by the embodiment may include a reference keypoint module 810, a predicted keypoint module 820, an optical flow estimation module 830, and an image prediction module 840.

The reference keypoint module 810 is configured to acquire target audio data and a target reference image and extract reference keypoints of a character from the target reference image.

The predicted keypoint module 820 is configured to: based on an image generation model, perform motion estimation using the target audio data and the reference keypoints to obtain predicted keypoints that match the target audio data.

The optical flow estimation module 830 is configured to: based on the image generation model, perform parameter estimation using the reference keypoints and the predicted keypoints to obtain motion parameters of the predicted keypoints and perform prior motion estimation using the motion parameters of the predicted keypoints to obtain optical flow of non-key pixel points.

The image prediction module 840 is configured to: based on the image generation model, perform image prediction using the target reference image and dense optical flow to obtain predicted image data that matches the target audio data, where the dense optical flow includes optical flow of the predicted keypoints and the optical flow of the non-key pixel points.

In an optional embodiment, the optical flow estimation module 830 includes a key optical flow unit and a pixel optical flow unit.

The key optical flow unit is configured to: based on the image generation model, obtain the optical flow of the predicted keypoints using coordinates of the predicted keypoints and coordinates of the reference keypoints.

The pixel optical flow unit is configured to perform parameter estimation using the optical flow of the predicted keypoints to obtain the motion parameters of the predicted keypoints, select auxiliary keypoints for the non-key pixel points from the predicted keypoints, and perform prior motion estimation using optical flow of the auxiliary keypoints and motion parameters of the auxiliary keypoints to obtain the optical flow of the non-key pixel points.

In an optional embodiment, the pixel optical flow unit includes a first optical flow subunit.

The first optical flow subunit is specifically configured to operate the following: determining a motion function obeyed by the predicted keypoints using the optical flow of the predicted keypoints, and taking a derivative of the motion function based on the Taylor distribution to obtain a first-order partial derivative and a second-order partial derivative of the predicted keypoints in a horizontal direction and a vertical direction; and performing prior motion estimation using coordinates of the non-key pixel points, coordinates of the auxiliary keypoints, and a first-order partial derivative and a second-order partial derivative of the auxiliary keypoints in the horizontal direction and the vertical direction to obtain the optical flow of the non-key pixel points.

In an optional embodiment, the pixel optical flow unit also includes a second optical flow subunit.

The second optical flow subunit is specifically configured to operate the following: determining influence weight of the auxiliary keypoints on the non-key pixel points based on the Gaussian distribution, by using the coordinates of the non-key pixel points, the coordinates of the auxiliary keypoints, and a learnable influence radius; and scaling the optical flow of the non-key pixel points using the influence weight of the auxiliary keypoints on the non-key pixel points to obtain scaled optical flow of the non-key pixel points.

In an optional embodiment, the pixel optical flow unit also includes a third optical flow subunit.

The third optical flow subunit is specifically configured to operate the following: correcting the optical flow of the non-key pixel points using a learnable optical flow offset to obtain corrected optical flow of the non-key pixel points.

In an optional embodiment, the reference keypoint module 810 is specifically configured to extract the reference keypoints and a reference portrait from the target reference image.

The image prediction module 840 includes a portrait encoding unit, a portrait decoding unit, and an image fusion unit.

The portrait encoding unit is configured to encode the reference portrait based on the image generation model to obtain a reference portrait feature.

The portrait decoding unit is configured to decode the reference portrait feature and the dense optical flow based on the image generation model to obtain predicted portrait data.

The image fusion unit is configured to fuse the predicted portrait data with a target background image to obtain the predicted image data that matches the target audio data.

In an optional embodiment, the image prediction module 840 also includes a target background unit.

The target background unit is specifically configured to operate the following: extracting a background image from the target reference image, supplementing the extracted background image, and using the supplemented background image as the target background image; or acquiring a customized background image to serve as the target background image.

In an optional embodiment, the predicted keypoint module 820 includes an audio encoding unit and a keypoint prediction unit.

The audio encoding unit is configured to encode the target audio data based on the image generation model to obtain an audio feature.

The keypoint prediction unit is configured to perform motion estimation using the reference keypoints and the audio feature to obtain the predicted keypoints that match the target audio data.

In an optional embodiment, the predicted keypoint module 820 is also configured to operate the following: acquiring keypoints of a customized action; and fusing the keypoints of the customized action with the predicted keypoints that match the target audio data to obtain new predicted keypoints.

The technical solutions provided by the embodiments of the present disclosure determine the motion parameters of the predicted keypoints and use the motion parameters of the predicted keypoints to perform motion estimation to obtain the optical flow of non-key pixel points, thereby obtaining dense optical flow. The dense optical flow is introduced as prior knowledge into the image generation process, improving the efficiency of image generation. In other words, a method for generating facial expressions and actions of a digital human based on second-order motion prior is proposed. This method enables the simultaneous generation of a digital human's facial expressions and limb movements through an end-to-end network. The method also supports user-defined actions and backgrounds, offering broad application scenarios.

Operations, including acquisition, storage, and application, on a user's personal information involved in the solution of the present disclosure conform to relevant laws and regulations and do not violate the public policy doctrine.

According to an embodiment of the present disclosure, the present disclosure also provides an electronic device, a readable storage medium, and a computer program product.

FIG. 9 is a block diagram of an electronic device for implementing a training method for an image generation model or an image generation method according to an embodiment of the present disclosure.

FIG. 9 is a block diagram illustrating an exemplary electronic device 900 that may be configured to perform embodiments of the present disclosure. The electronic device is intended to represent various forms of digital computers, for example, a laptop computer, a desktop computer, a workbench, a personal digital assistant, a server, a blade server, a mainframe computer, or another applicable computer. The electronic device may also represent various forms of mobile apparatuses, for example, a personal digital assistant, a cellphone, a smartphone, a wearable device, or a similar computing apparatus. Herein the shown components, the connections and relationships between these components, and the functions of these components are illustrative only and are not intended to limit the implementation of the present disclosure as described and/or claimed herein.

As shown in FIG. 9, the electronic device 900 includes a computing unit 901. The computing unit 901 may perform various types of appropriate operations and processing based on a computer program stored in a read-only memory (ROM) 902 or a computer program loaded from a storage unit 908 to a random-access memory (RAM) 903. Various programs and data required for the operation of the electronic device 900 may also be stored in the RAM 903. The computing unit 901, the ROM 902, and the RAM 903 are connected to each other by a bus 904. An input/output (I/O) interface 905 is also connected to the bus 904.

Multiple components in the electronic device 900 are connected to the I/O interface 905. The multiple components include an input unit 906 such as a keyboard and a mouse, an output unit 907 such as various types of displays and speakers, the storage unit 908 such as a magnetic disk and an optical disk, and a communication unit 909 such as a network card, a modem, and a wireless communication transceiver. The communication unit 909 allows the electronic device 900 to exchange information/data with other devices over a computer network such as the Internet and/or various telecommunications networks.

The computing unit 901 may be various general-purpose and/or special-purpose processing components having processing and computing capabilities. Examples of the computing unit 901 include, but are not limited to, a central processing unit (CPU), a graphics processing unit (GPU), a special-purpose artificial intelligence (AI) computing chip, a computing unit executing machine learning model algorithms, a digital signal processor (DSP), and any appropriate processor, controller, and microcontroller. The computing unit 901 executes various methods and processing described above, such as the training method for an image generation model or the image generation method. For example, in some embodiments, the training method for an image generation model or the image generation method may be implemented as a computer software program tangibly contained in a machine-readable medium such as the storage unit 908. In some embodiments, part or all of computer programs may be loaded and/or installed on the electronic device 900 via the ROM 902 and/or the communication unit 909. When the computer programs are loaded into the RAM 903 and executed by the computing unit 901, one or more steps of the preceding training method for an image generation model or the image generation method may be performed. Alternatively, in other embodiments, the computing unit 901 may be configured, in any other suitable manner (for example, by means of firmware), to execute the training method for an image generation model or the image generation method.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SOCs), complex programmable logic devices (CPLDs), computer hardware, firmware, software, and/or combinations thereof. The various embodiments may include implementations in one or more computer programs. The one or more computer programs may be executable and/or interpretable on a programmable system including at least one programmable processor. The programmable processor may be a special-purpose or general-purpose programmable processor for receiving data and instructions from a memory system, at least one input apparatus and at least one output apparatus and transmitting the data and instructions to the memory system, the at least one input apparatus and the at least one output apparatus.

Program codes for implementation of the methods of the present disclosure may be written in one programming language or any combination of multiple programming languages. The program codes may be provided for the processor or controller of a general-purpose computer, a special-purpose computer or another programmable data processing apparatus to enable functions/operations specified in flowcharts and/or block diagrams to be implemented when the program codes are executed by the processor or controller. The program codes may be executed entirely on a machine or may be executed partly on a machine. As a stand-alone software package, the program codes may be executed partly on a machine and partly on a remote machine or may be executed entirely on a remote machine or a server.

In the context of the present disclosure, the machine-readable medium may be a tangible medium that may include or store a program that is used by or used in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. Concrete examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any appropriate combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein) or a computing system including any combination of such back-end, middleware or front-end components. Components of a system may be interconnected by any form or medium of digital data communication (for example, a communication network). Examples of the communication network include a local area network (LAN), a wide area network (WAN), and the Internet.

A computing system may include a client and a server. The client and the server are usually far away from each other and generally interact through the communication network. The relationship between the client and the server arises by virtue of computer programs running on respective computers and having a client-server relationship to each other. The server may be a cloud server, a server of a distributed system, or a server combined with a blockchain.

Artificial intelligence is the study of making computers simulate certain human thinking processes and intelligent behaviors (such as learning, reasoning, thinking and planning) both at the hardware and software levels. Artificial intelligence hardware technology generally includes, for example, sensors, special-purpose artificial intelligence chips, cloud computing, distributed storage, and big data processing. Artificial intelligence software technology mainly includes several major directions including computer vision technology, speech recognition technology, natural language processing technology, machine learning/deep learning technology, big data processing technology, and knowledge mapping technology.

Cloud computing refers to a technical system that accesses a shared elastic-and-scalable physical or virtual resource pool through a network, where resources may include servers, operating systems, networks, software, applications, and storage devices and may be deployed and managed in an on-demand, self-service manner by cloud computing. Cloud computing can provide efficient and powerful data processing capabilities for artificial intelligence, the blockchain and other technical applications and model training.

It is to be understood that various forms of the preceding flows may be used with steps reordered, added, or removed. For example, the steps described in the present disclosure may be executed in parallel, in sequence or in a different order as long as the desired results of the technical solutions disclosed in the present disclosure can be achieved. The execution sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modification, equivalent substitution, improvement and the like made within the spirit and principle of the present disclosure falls within the scope of the present disclosure.

What is claimed is:

1. A training method for an image generation model, comprising:
acquiring sample audio data, a sample reference image, and annotated image data, and extracting reference keypoints of a character from the sample reference image;
performing, based on a model to be trained, motion estimation using the sample audio data and the reference keypoints to obtain predicted keypoints that match the sample audio data;
performing, based on the model to be trained, parameter estimation using the reference keypoints and the predicted keypoints to obtain motion parameters of the predicted keypoints, and performing prior motion estimation using the motion parameters of the predicted keypoints to obtain optical flow of non-key pixel points;
performing, based on the model to be trained, image prediction using the sample reference image and dense optical flow to obtain predicted image data that matches the sample audio data, wherein the dense optical flow comprises optical flow of the predicted keypoints and the optical flow of the non-key pixel points; and
performing model training using the predicted image data and the annotated image data to obtain the image generation model.

2. The method of claim 1, wherein performing, based on the model to be trained, parameter estimation using the reference keypoints and the predicted keypoints to obtain the motion parameters of the predicted keypoints and performing prior motion estimation using the motion parameters of the predicted keypoints to obtain the optical flow of the non-key pixel points comprise:
obtaining, based on the model to be trained, the optical flow of the predicted keypoints using coordinates of the predicted keypoints and coordinates of the reference keypoints; and
performing parameter estimation using the optical flow of the predicted keypoints to obtain the motion parameters of the predicted keypoints, selecting auxiliary keypoints for the non-key pixel points from the predicted keypoints, and performing prior motion estimation using optical flow of the auxiliary keypoints and motion parameters of the auxiliary keypoints to obtain the optical flow of the non-key pixel points.

3. The method of claim 2, wherein performing parameter estimation using the optical flow of the predicted keypoints to obtain the motion parameters of the predicted keypoints, selecting the auxiliary keypoints for the non-key pixel points from the predicted keypoints, and performing prior motion estimation using the optical flow of the auxiliary keypoints and the motion parameters of the auxiliary keypoints to obtain the optical flow of the non-key pixel points comprise:
determining a motion function obeyed by the predicted keypoints using the optical flow of the predicted keypoints, and taking a derivative of the motion function based on Taylor distribution to obtain a first-order partial derivative and a second-order partial derivative of the predicted keypoints in a horizontal direction and a vertical direction; and
performing prior motion estimation using coordinates of the non-key pixel points, coordinates of the auxiliary keypoints, and a first-order partial derivative and a second-order partial derivative of the auxiliary keypoints in the horizontal direction and the vertical direction to obtain the optical flow of the non-key pixel points.

4. The method of claim 3, after obtaining the optical flow of the non-key pixel points, further comprising:
determining influence weight of the auxiliary keypoints on the non-key pixel points based on Gaussian distribution, by using the coordinates of the non-key pixel points, the coordinates of the auxiliary keypoints, and a learnable influence radius; and
scaling the optical flow of the non-key pixel points using the influence weight of the auxiliary keypoints on the non-key pixel points to obtain scaled optical flow of the non-key pixel points.

5. The method of claim 3, after obtaining the optical flow of the non-key pixel points, further comprising:
correcting the optical flow of the non-key pixel points using a learnable optical flow offset to obtain corrected optical flow of the non-key pixel points.

6. The method of claim 1, wherein extracting the reference keypoints of the character from the sample reference image comprises extracting the reference keypoints, a reference portrait, and a background image from the sample reference image, and supplementing the background image to obtain a supplemented background image; and
performing, based on the model to be trained, image prediction using the sample reference image and the dense optical flow to obtain the predicted image data that matches the sample audio data comprises:
encoding the reference portrait based on the model to be trained to obtain a reference portrait feature;
decoding the reference portrait feature and the dense optical flow based on the model to be trained to obtain predicted portrait data; and
fusing the predicted portrait data with the supplemented background image to obtain the predicted image data that matches the sample audio data.

7. The method of claim 1, wherein performing, based on the model to be trained, image prediction using the sample reference image and the dense optical flow to obtain the predicted image data that matches the sample audio data comprises:
masking the dense optical flow based on the model to be trained to obtain masked dense optical flow; and
performing image prediction using the sample reference image and the masked dense optical flow to obtain the predicted image data that matches the sample audio data.

8. The method of claim 1, wherein performing, based on the model to be trained, motion estimation using the sample audio data and the reference keypoints to obtain the predicted keypoints that match the sample audio data comprises:
encoding the sample audio data based on the model to be trained to obtain an audio feature; and
performing motion estimation using the reference keypoints and the audio feature to obtain the predicted keypoints that match the sample audio data.

9. An image generation method, comprising:
acquiring target audio data and a target reference image, and extracting reference keypoints of a character from the target reference image;
performing, based on an image generation model, motion estimation using the target audio data and the reference keypoints to obtain predicted keypoints that match the target audio data;
performing, based on the image generation model, parameter estimation using the reference keypoints and the predicted keypoints to obtain motion parameters of the predicted keypoints, and performing prior motion estimation using the motion parameters of the predicted keypoints to obtain optical flow of non-key pixel points; and
performing, based on the image generation model, image prediction using the target reference image and dense optical flow to obtain predicted image data that matches the target audio data, wherein the dense optical flow comprises optical flow of the predicted keypoints and the optical flow of the non-key pixel points.

10. The method of claim 9, wherein performing, based on the image generation model, parameter estimation using the reference keypoints and the predicted keypoints to obtain the motion parameters of the predicted keypoints and performing prior motion estimation using the motion parameters of the predicted keypoints to obtain the optical flow of the non-key pixel points comprise:
obtaining, based on the image generation model, the optical flow of the predicted keypoints using coordinates of the predicted keypoints and coordinates of the reference keypoints; and
performing parameter estimation using the optical flow of the predicted keypoints to obtain the motion parameters of the predicted keypoints, selecting auxiliary keypoints for the non-key pixel points from the predicted keypoints, and performing prior motion estimation using optical flow of the auxiliary keypoints and motion parameters of the auxiliary keypoints to obtain the optical flow of the non-key pixel points.

11. The method of claim 10, wherein performing parameter estimation using the optical flow of the predicted keypoints to obtain the motion parameters of the predicted keypoints, selecting the auxiliary keypoints for the non-key pixel points from the predicted keypoints, and performing prior motion estimation using the optical flow of the auxiliary keypoints and the motion parameters of the auxiliary keypoints to obtain the optical flow of the non-key pixel points comprise:
determining a motion function obeyed by the predicted keypoints using the optical flow of the predicted keypoints, and taking a derivative of the motion function based on Taylor distribution to obtain a first-order partial derivative and a second-order partial derivative of the predicted keypoints in a horizontal direction and a vertical direction; and
performing prior motion estimation using coordinates of the non-key pixel points, coordinates of the auxiliary keypoints, and a first-order partial derivative and a second-order partial derivative of the auxiliary keypoints in the horizontal direction and the vertical direction to obtain the optical flow of the non-key pixel points.

12. The method of claim 11, after obtaining the optical flow of the non-key pixel points, further comprising:
determining influence weight of the auxiliary keypoints on the non-key pixel points based on Gaussian distribution, by using the coordinates of the non-key pixel points, the coordinates of the auxiliary keypoints, and a learnable influence radius; and
scaling the optical flow of the non-key pixel points using the influence weight of the auxiliary keypoints on the non-key pixel points to obtain scaled optical flow of the non-key pixel points.

13. The method of claim 11, after obtaining the optical flow of the non-key pixel points, further comprising:
correcting the optical flow of the non-key pixel points using a learnable optical flow offset to obtain corrected optical flow of the non-key pixel points.

14. The method of claim 9, wherein extracting the reference keypoints of the character from the target reference image comprises extracting the reference keypoints and a reference portrait from the target reference image; and
performing, based on the image generation model, image prediction using the target reference image and the dense optical flow to obtain the predicted image data that matches the target audio data comprises:
encoding the reference portrait based on the image generation model to obtain a reference portrait feature;
decoding the reference portrait feature and the dense optical flow based on the image generation model to obtain predicted portrait data; and
fusing the predicted portrait data with a target background image to obtain the predicted image data that matches the target audio data.

15. The method of claim 14, further comprising:
extracting a background image from the target reference image, supplementing the extracted background image, and using the supplemented background image as the target background image; or
acquiring a customized background image to serve as the target background image.

16. The method of claim 9, wherein performing, based on the image generation model, motion estimation using the target audio data and the reference keypoints to obtain the predicted keypoints that match the target audio data comprises:
encoding the target audio data based on the image generation model to obtain an audio feature; and
performing motion estimation using the reference keypoints and the audio feature to obtain the predicted keypoints that match the target audio data.

17. The method of claim 9, further comprising:
acquiring keypoints of a customized action; and
fusing the keypoints of the customized action with the predicted keypoints that match the target audio data to obtain new predicted keypoints.

18. An electronic device, comprising:
at least one processor; and
a memory communicatively connected to the at least one processor;
wherein the memory stores instructions executable by the at least one processor, and the instructions are executed by the at least one processor to cause the at least one processor to perform the following steps:
acquiring sample audio data, a sample reference image, and annotated image data, and extracting reference keypoints of a character from the sample reference image;
performing, based on a model to be trained, motion estimation using the sample audio data and the reference keypoints to obtain predicted keypoints that match the sample audio data;
performing, based on the model to be trained, parameter estimation using the reference keypoints and the predicted keypoints to obtain motion parameters of the predicted keypoints, and performing prior motion estimation using the motion parameters of the predicted keypoints to obtain optical flow of non-key pixel points;
performing, based on the model to be trained, image prediction using the sample reference image and dense optical flow to obtain predicted image data that matches the sample audio data, wherein the dense optical flow comprises optical flow of the predicted keypoints and the optical flow of the non-key pixel points; and
performing model training using the predicted image data and the annotated image data to obtain the image generation model.

19. An electronic device, comprising:
at least one processor; and
a memory communicatively connected to the at least one processor;
wherein the memory stores instructions executable by the at least one processor, and the instructions are executed by the at least one processor to cause the at least one processor to perform the method of claim 17.

20. A non-transitory computer-readable storage medium storing computer instructions for causing a computer to perform the method of claim 1.
